(19) United States
(12) Patent Application Publication
(10) Pub. No.: US 2005/0222854 A1
(43) Pub. Date: Oct. 6, 2005

(54) Automatically processing an expense report using an expense report agent

(75) Inventors: Jonathan Dale, San Franciso, CA (US); Francis G. McCabe, Palo Alto, CA (US)

Correspondence Address: BAKER BOTTS L.L.P., 2001 ROSS AVENUE, SUITE 600, DALLAS, TX, 75201-2980, US

(73) Assignee: Fujitsu Limited

(21) Appl. No.: 10/816,723

(22) Filed: Apr. 2, 2004

(51) Int. Cl. G06F 17/60

(52) U.S. Cl. 705/1

(57) ABSTRACT

Processing an expense report includes receiving transaction identifiers at an expense report agent, where a transaction identifier corresponds to a transaction. The expense report requests reimbursement for any number of transactions. Transaction information corresponding to the transaction identifiers is automatically requested from any number of retailer systems. The transaction information is received from the retailer systems, and is provided in a machine-readable format. The transaction information is inserted into the expense report to request the reimbursement for the transactions, and the expense report is evaluated to determine the reimbursement.

### TECHNICAL FIELD OF THE INVENTION

The present invention relates generally to expense reimbursement techniques and more particularly to automatically processing an expense report using an expense report agent.

### BACKGROUND

An employee of a company may incur reimbursable business expenses while performing business-related activities for the company. A company expense policy may define the types and amounts of reimbursable expenses. For example, reimbursement may be available for only certain types of expenses or up to specified amounts. According to known techniques, the employee typically collects receipts for the expenses and completes an expense report in order to request a reimbursement. According to one known technique, the employee may complete the expense report on-line. The company determines whether and how much of the expenses are reimbursable according to the company policy. These known techniques, however, are typically inefficient. It is generally desirable to have an efficient technique for reimbursing business expenses.

### SUMMARY OF THE INVENTION

In accordance with the present invention, techniques for processing an expense report are provided. According to particular embodiments, these techniques enable agents to automatically process an expense report.

According to a particular embodiment, processing an expense report includes receiving transaction identifiers at an expense report agent, where a transaction identifier corresponds to a transaction. The expense report requests reimbursement for any number of transactions. Transaction information corresponding to the transaction identifiers is automatically requested from any number of retailer systems. The transaction information is received from the retailer systems, and is provided in a machine-readable format. The transaction information is inserted into the expense report to request the reimbursement for the transactions, and the expense report is evaluated to determine the reimbursement.

Certain embodiments of the invention may provide various technical advantages. According to one embodiment, information about a transaction with a retailer may be collected directly from the retailer. According to another embodiment, an expense report may be automatically validated with respect to an expense policy, and expense report line items that deviate from the expense policy may be automatically marked. According to yet another embodiment, authorization for line items of an expense report may be automatically requested.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 illustrates one embodiment of a system for automatically processing an expense report using an expense report agent that operates according to particular embodiments of the present invention;

FIG. 2 is a block diagram illustrating exemplary functional elements of an agent of the system of FIG. 1; and

FIGS. 3A and 3B illustrate a flowchart illustrating one embodiment of a method for processing an expense report using an expense report agent.

### DETAILED DESCRIPTION OF THE DRAWINGS

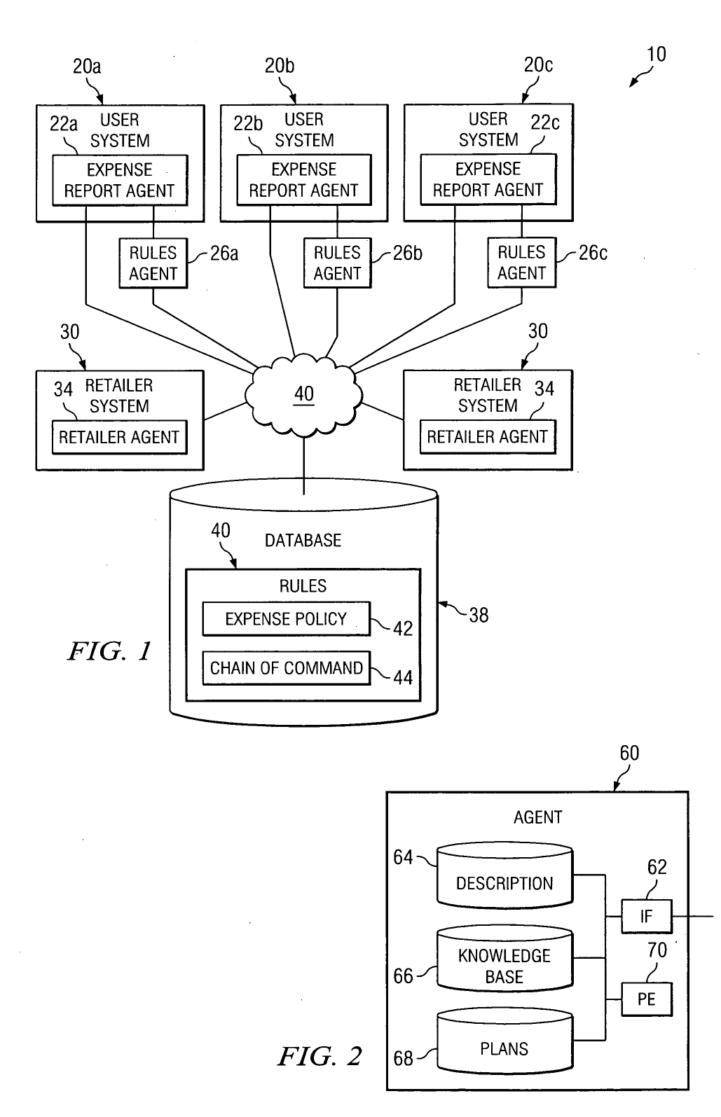

FIG. 1 illustrates one embodiment of a system 10 for automatically processing an expense report using an expense report agent. System 10 includes one or more user systems 20, each including an expense report agent 22, one or more rules agents 26, one or more retailer systems 30, each including a retailer agent 34, and a database 38 coupled as illustrated through a communication network 40. In general, a user represents an employee of a company. The user purchases a product such as a good or service from a retailer during a transaction. The user uses expense report agent 22, which interacts with retailer agents 34 and rules agents 26, to request a reimbursement for the expense.

According to one embodiment, a retailer refers to an entity sells a product such as a good or service to a user. A transaction refers to an exchange of the product given by the retailer to the user for compensation given by the user to the retailer. A retailer may comprise a service provider that provides services to the user such as a restaurant, a hotel, a travel agent, other service provider, or any combination of the preceding. A retailer may comprise a supplier that provides goods to the user such as an office supply company, a furniture rental company, other supplier, or any combination of the preceding.

Retailer system 30 represents any suitable collection of components used by a retailer to sell a product to a user. For example, retailer system 30 may include a computing system with an interface, a processor, and memory. As used in this document, the term “interface” refers to any suitable structure of a device operable to receive input for the device, send output from the device, or both, and may comprise one or more ports. As used in this document, the term “processor” refers to any suitable device operable to execute instructions and manipulate data to perform operations. As used in this document, the term “memory” refers to any structure operable to store and facilitate retrieval of information used by a processor, and may comprise Random Access Memory (RAM), Read Only Memory (ROM), magnetic drives, disk drives, Compact Disk (CD) Drives, Digital Video Disk (DVD) drives, removable media storage, any other suitable data storage device, or a combination of any of the preceding.

Retailer system 30 may offer machine-readable interfaces that enable structured queries to access and interact with information regarding the retailer. To provide these operations, retailer system 30 may support any number of features and provide an interface to each one of these features. For example, a hotel retailer system may offer features such as a reservation availability query feature or a reservation request feature. As another example, an office supply retailer system 30 may offer features such as an on-line ordering feature. According to particular embodiments, retailer system 30 may operate according to publicly developed and available standards for communication.

A user system 20 represents any suitable combination and arrangement of components that enable interaction with users and other elements of system 10. For example, user system 20 may include a computing system with an interface, a processor, and memory. User system 20 may include a user interface that displays a template such as an expense authorization request template or an expense report template that a user may complete on-line. The user interface may also be used to display an expense authorization request or an expense report for a user to approve or authorize.

Database 38 encodes constraints of the reimbursement procedure such as expense policy 42 and chain of command 44 as machine-readable rules 40. Rules 40 describe the requirements of the reimbursement procedure, and may also specify other requirements. According to one embodiment, rules 40 may specify the format of information to be entered into an on-line template. For example, certain windows of the template may require numerical values. An employer may encode expense policy 42 and chain of command 44 in database 34 using expense report agent 22.

Expense policy 42 defines requirements for reimbursable expenses. The requirements may define types of reimbursable expenses, maximum amounts for reimbursable expenses, retailers that must be used, other requirements, or any combination of the preceding. For example, reimbursable expenses may include hotel, restaurant, or rental car expenses, while non-reimbursable expenses may include movie charges, mini-bar charges, or long-distance telephone charges. As another example, a reimbursable expense may have a maximum limit that may reimbursed. As yet another example, an expense may be reimbursed only after a specified authorization procedure has been performed. For example, hotel expenses above a maximum amount may be reimbursed if a specified authorization procedure is performed. A reimbursement for an expense may refer to a payment to the user for at least some of the expense.

Chain of command 44 defines an ordered set of one or more users, or authorities, that may be required to authorize reimbursement for expenses. According to one embodiment, a specific chain of command may be specified for a specific type of request. For example, a lower-hierarchy chain of command may be specified for smaller expenses, while a higher-hierarchy chain of command may be specified for larger expenses. As another example, a higher-hierarchy chain of command may be specified for reimbursements requested by users of a lower hierarchy.

According to the illustrated embodiment, expense report agent 22 interacts with other agents to process an expense report, which may include submitting, authorizing, approving, and reimbursing the expense report. An expense report refers to a listing of expenses for which reimbursement is being requested. The expense report may include line items, where each line item describes a transaction or an expense of a transaction. A user may complete an expense report using expense report agent 22 by filling in an on-line expense report template. The user may provide a transaction identifier operable to uniquely identify transaction. A transaction identifier may include, for example, the name of the retailer, a receipt number, the date of the transaction, other identifier for the transaction, or any combination of the preceding. Expense report agent 22 may contact retailer agent 34 to request information about the transaction in accordance with a transaction identifier supplied by the user.

Retailer agent 34 provides transaction information about the transaction to expense report agent 22. Transaction information may include transaction descriptors such as the name of the retailer, the type of transaction, the date of the transaction, the products provided, the user receiving the products, the amount of the expense, the method of payment, other suitable descriptor of the transaction, or any combination of the preceding.

As an example, transaction information from a restaurant may include the name of the restaurant, the date of the transaction, the items provided, the number of people to which the items were provided, or any combination of the preceding. The items provided may be detailed to list the entrees, main courses, desserts, alcohol, or other items. As another example, transaction information from a hotel may include the room charge, the mini-bar charge, the telephone charges, other charges, or any combination of the preceding. As another example, transaction information from an office supply company may include the name of the company, the items provided, the cost of each item, the total cost, and the name of the user. Retailer agent 34 may have an interface that provides electronic receipts that include the transaction information in a machine-readable format.

Expense report agent 22 may interact with rules agent 26 to determine if the expense report conforms to rules 40. Rules agent 26 reads rules 40 from database 38, applies rules 40 to the line items of the expense report, and reports any non-conforming line items to expense report agent 22. Expense report agent 22, however, may operate independently to determine if the expense report conforms to rules 40. Expense report agent 22 may read rules 40 from database 38 and apply rules 40 to the line items of the expense report.

Communication network 40 allows the components of system 10 to communicate with each other or with other networks or devices. Communication network 40 may comprise all or a portion of public switched telephone network (PSTN), a public or private data network, a local area network (LAN), a metropolitan area network (MAN), a wide area network (WAN), a global computer network such as the Internet, a wireline or wireless network, a local, regional, or global communication network, an enterprise intranet, other suitable communication link, or any combination of the preceding.

Standard technologies may be used to provide interoperability between components of system 10. Standard technologies may include, for example, Simple Object Access Protocol (SOAP), Web Services Description Language (WSDL), Choreography, DARPA Agent Markup Language/Ontology Web Language (DAML/OWL), Universal Description, Discovery, and Integration (UDDI), other suitable standard technology, or any combination of the preceding.

The illustration and the description provided present generic elements for implementing a system to enable processing of an expense report. While the embodiment illustrated includes specific components arranged and operating in particular ways, however, it should be understood that the illustration, the description, and all examples given are provided only to aid in clarifying the basic concepts of these techniques, and none of these are intended to limit the scope of these concepts. As used in this document, “each” refers to each member of a set or each member of a subset of the set.

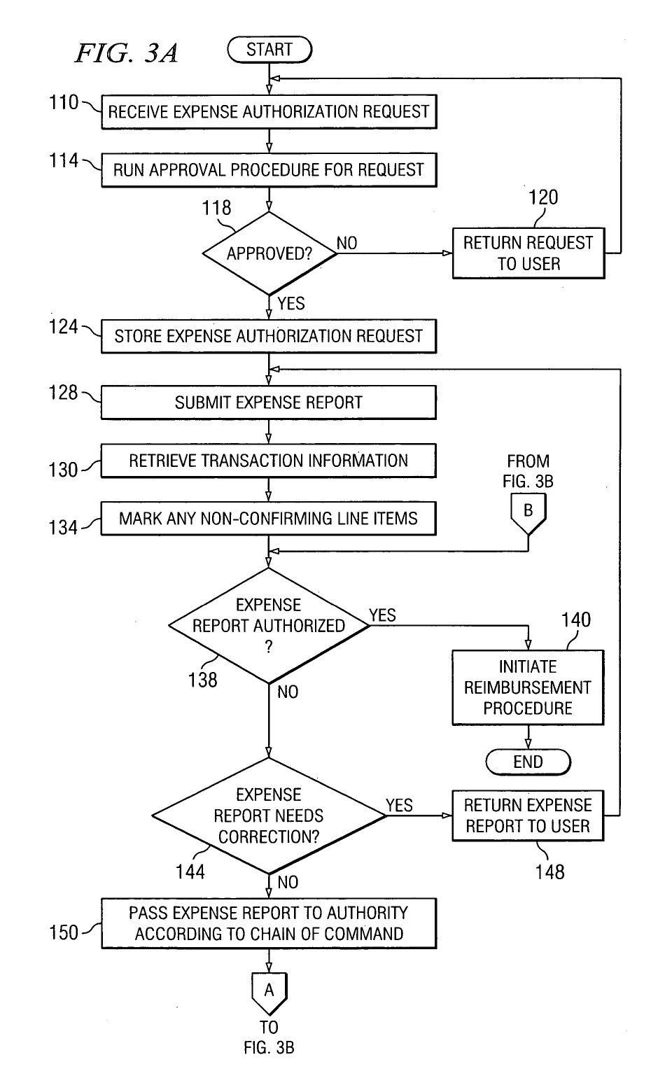

FIG. 2 is a block diagram illustrating exemplary functional elements for an agent 60 that includes an interface 62, a description 64, a knowledge base 66, one or more plans 68, and a processing engine 70. Because the operation of many agents such as expense report agent 22, retailer agent 34, and rules agent 26 may be similar, agent 60 and its elements and operations may be described below both generically and specifically with respect to particular types of agents. In general, agent 60 uses processing engine 70 to process information from plans 68 using data contained within description 64 and knowledge base 66 in order to process expense reports.

Plans 68 set forth the specific operation of an agent 50. For example, a plan 68 for expense report agent 22 may comprise an expense report submitted by the user to request a reimbursement. An expense report includes line items that may need to be approved and authorized by expense report agent 22.

Description 64 includes any number of descriptors specifying information associated with the entity served by agent 60. Description 64 may be stored at any suitable memory or database, and some or all of description 64 may be exposed to other entities during various operations. As an example, a user agent 60 may maintain description 44 that includes a number of user descriptors that range from general to report-specific descriptors. General user descriptors may include descriptors used to identify and describe the user. For example, general user descriptors may include a user identifier such as a name or employee number, the level of the user within the corporate hierarchy, a job title, other descriptor of the user, or any combination of the preceding. Report-specific descriptors refer to specific or dynamic descriptors that identify and describe a specific expense report. For example, report-specific descriptors may include a description of the business activity for the expense report.

A retailer agent 60 may maintain description 64 that includes retailer descriptors describing the retailer. Retailer descriptors may include, for example, the nature of the retailer, how to locate and interface with retailer system 30, the interface languages supported by retailer system 30, other appropriate information, or any combination of the preceding. For example, general retailer descriptors for a restaurant may include the name, location, type of restaurant, price range, interface languages supported, other appropriate general information, or any combination of the preceding. Retailer descriptors may also include precise features offered by retailer system 30 and techniques for interfacing with those features. For example, specific retailer descriptors for a restaurant may identify features, such as a restaurant reservation feature, and specify specific syntax for interfacing with these features.

Knowledge base 66 includes information for use by agent 60 to make decisions, negotiate with other agents, perform other operational tasks, or any combination of the preceding, and may use any suitable technique for searching for the information such as the structured query language (SQL) technique. According to particular embodiments, knowledge base 66 may represent one or more legacy or other enterprise systems maintaining business knowledge for an organization. Accordingly, agent 60 can access and make decisions based upon actual information within an enterprise, while providing a wrapper of services around a central knowledge bank. Typically, agent 60 maintains most or all of knowledge base 66 hidden from other entities during operation.

Interface 62 provides a link between agent 60 and other entities of system 10. Depending upon the particular types of communications and configurations within system 10, interface 62 may include any suitable combination of hardware, software, or other logic for interacting with other components. Processing engine 70 attempts to perform the operations set forth by plans 68.

Agent 60 may run on any suitable computer using any suitable operating system such as the APPLE MacOS, MICROSOFT WINDOWS, or REDHAT Linux/Unix operating system. Agent 60 may have any suitable platform such as an Agent Process Interaction Language (April) Agent Platform. The platform may be compliant with any suitable standard or procedure such as with Foundation for Intelligent Physical Agents (FIPA), Web Services, or Semantic Web standards or procedures. Agent 60 may be provided using any suitable programming language such as April, Go!, other suitable programming language, or any combination of the preceding. Other suitable programming technologies may be used as well such as DialoX or Java.

While the embodiment illustrated and the description provided focus on a particular example of agent 60 that includes specific elements providing particular functions, system 10 contemplates agents 60 having any suitable combination and arrangement of elements to support composition of remote services. Thus, the functionalities performed by the particular elements illustrated may be separated or combined as appropriate, and functionalities of some or all of these elements may be implemented by logic encoded in media. Moreover, some or all of the functionalities of agent 60 may be combined or distributed among other elements of system 10.

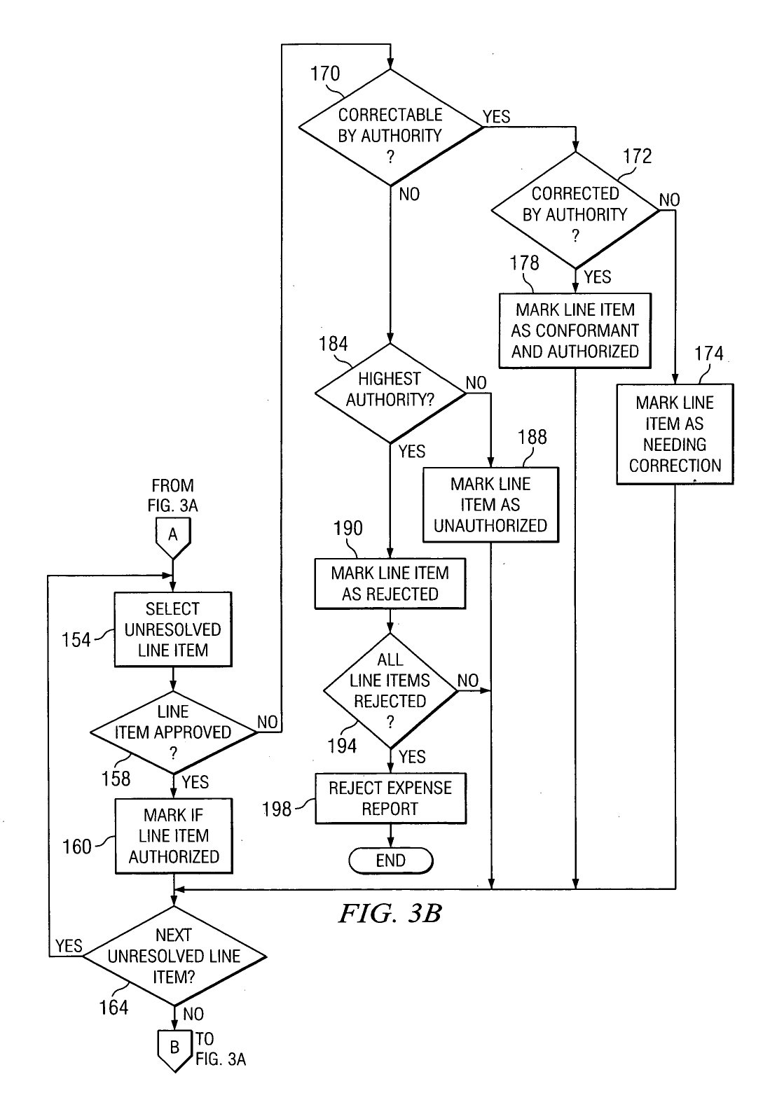

FIGS. 3A and 3B illustrate a flowchart illustrating one embodiment of a method for processing an expense report using expense report agent 22. The method begins at step 110, where expense report agent 22 receives an expense authorization request for a business activity. The expense authorization request may request authorization for a future business activity that may result in associated business expenses. The expense authorization request may set a budget for the business expenses, and may be used to define limits on the business expenses incurred during the business activity. An approved expense authorization request may refer to a purchase requisition, a travel authorization, or direct authority approval.

Expense report agent 22 runs an approval procedure for the expense authorization request at step 114. If the expense authorization request is not approved at step 118, the expense authorization request is returned to the user at step 120, and the method returns to step 110. If the expense authorization request is approved at step 118, the method proceeds to step 124, where the approved expense authorization request is stored. The approved expense authorization request may be stored as a part of rules 40.

After the business activity has occurred, an expense report for the business activity is submitted to expense report agent 22 at step 128. A user may use a user interface of user system 20 to input information into an on-line expense report template. The user may provide transaction identifiers that identify the transactions of the expense report, and may sign the expense report with an electronic signature. Expense report agent 22 retrieves transaction information about the transaction from one or more retailer agents 34 using the transaction identifiers at step 130. Expense report agent 22 may automatically retrieve this information as the user is completing the expense report template, after the user has completed the expense report template or both. The transaction information may be inserted into the expense report.

Non-conforming line items are marked at step 134. Non-conforming line items refer to line items that do not conform to rules 40. Business expense logic embodying rules 40 may be applied to the line items in order to identify non-conforming line items. Expense report agent 33 determines whether the expense report is authorized at step 138. The expense report may be authorized when all the line items of the expense report have satisfied the requirements of rules 40. As an example, the expense report may be for a transaction of an expense report that has already been approved and does not require further authorization. As another example, the expense report may have been authorized during a previous iteration of the method. As another example, the expense report may be for expenses incurred by a user who does not require authorization. If the expense report has been authorized at step 138, the method proceeds to step 140. At step 140, expense report agent 22 initiates a reimbursement procedure. Expense report agent 22 may contact an accounting agent to initiate the reimbursement procedure. After initiating the reimbursement procedure, the method terminates. While performing the method, expense report agent 22 may store an audit trail of requests, rejections, an approvals, which may be provided after the method terminates.

If the expense report has not been authorized at step 138, the method proceeds to step 144. Expense report agent 22 determines whether the expense report needs correction at step 144. For example, the expense report may include non-conforming line items. If the expense report needs correction, the report is returned to the user at step 148. The user may revise a line item such as the amount of the expense to attempt to make the line item comply, or the user may add a comment explaining why the expenses was incurred or why the amount of the expense was different from the authorized amount. The method then returns to step 128, where the expense report is resubmitted. If the expense report does not need correction at step 144, the method proceeds to step 150.

The expense report is passed to the appropriate authority according to chain of command 44 at step 150. An unresolved line item selected at step 154. An unresolved line item refers to a line item that has not been authorized or rejected. If the line item has been approved at step 158, the method proceeds to step 160, where the line item is marked if it is authorized. If the current authority approves the line item and has the authority to approve the line item, the line item is marked as conformant and authorized. If the current authority approves the line item but does not have the authority to approve the line item, the line item is marked as conformant but unauthorized. An authority may be required to give a reason for not approving a line item. If there is a next unresolved line item at step 164, the method returns to step 154 to select the next unresolved line item. If there is no next unresolved line item at step 164, the method returns to step 138, where expense report agent 22 determines if the expense report has been authorized.

If the line item is not approved at step 158, the method proceeds to step 170, where expense report agent 22 determines if the line item is correctable by the current authority. If the line item is correctable by the current authority at step 170, the method proceeds to step 172. If the line item is not corrected by the current authority at step 172, the method proceeds to step 174, where the line item is marked as needing correction. After marking the line item, the method returns to step 164 to determine if there is a next unresolved line item. If the line item is corrected by the current authority at step 172, the method proceeds to step 178, where the line item is marked as conformant and authorized. After marking the line item, the method returns to step 164 to determine if there is a next unresolved line item.

If the line item is not correctable by the current authority, the method proceeds to step 184. If the current authority is not the highest authority for the line item at step 184, the method proceeds to step 188, where the line item is marked as unauthorized. The method then returns to step 164 to determine if there is a next unresolved line item. If the current authority is the highest authority at step 184, the method proceeds to step 190, where the line item is marked as rejected. If there are line items that have not been rejected at step 194, the method returns to step 164 to determine if there is a next unresolved line item. If all line items have been rejected at step 194, the method proceeds to step 198. At step 198, expense report agent 22 rejects the expense report. After rejecting the expense report, the method terminates.

The flowchart and description provided illustrate a brief method for expense report agent 22 to process an expense report. The flowchart and description, however, illustrate only an exemplary method of operation, and system 10 contemplates agents, other suitable components, or both agents and other suitable components using any appropriate techniques to provide these functionalities. Many of the steps of the flowchart may take place simultaneously, in different order, or both simultaneously and in different order than as shown. In addition, agents may use methods with additional steps, fewer steps, different steps, or any combination of the preceding so long as the methods remain appropriate.

Although the present invention has been described in several embodiments, a myriad of changes and modifications may be suggested to one skilled in the art, and it is intended that the present invention encompass such changes and modifications as fall within the scope of the present appended claims.

1. A method for processing an expense report, comprising:
receiving at an expense report agent one or more transaction identifiers associated with an expense report, a transaction identifier corresponding to a transaction of one or more transactions, the expense report requesting reimbursement for the one or more transactions;
automatically requesting transaction information corresponding to the one or more transaction identifiers from one or more retailer systems;
receiving the transaction information from the one or more retailer systems, the transaction information provided in a machine-readable format;
inserting the transaction information into the expense report to request the reimbursement for the one or more transactions; and
evaluating the expense report at the expense report agent to determine the reimbursement.

2. The method of claim 1, further comprising performing at least one of the following in response to the evaluation:
initiating the reimbursement for the one or more transactions;
denying the reimbursement for the one or more transactions; and
returning the expense report to a user system associated with the expense report.

3. The method of claim 1, wherein evaluating the expense report at the expense report agent to determine the reimbursement further comprises:
accessing an expense policy governing the expense report; and
evaluating the expense report in accordance with the expense policy.

4. The method of claim 1, wherein evaluating the expense report at the expense report agent to determine the reimbursement further comprises:
determining that an expense authorization request is approved; and
evaluating the expense report in accordance with the expense authorization request.

5. The method of claim 1, wherein evaluating the expense report at the expense report agent to determine the reimbursement further comprises:
identifying a non-conforming line item of a plurality of line items of the expense report;
retrieving a chain of command corresponding to the non-conforming line item, the chain of command comprising a sequence of authorities; and
performing the following for at least one authority of the sequence of authorities until the non-conforming line item is resolved;
selecting an authority of the sequence of authorities as a current authority;
sending the expense report to an authority expense report agent corresponding to the current authority;
determining if the non-conforming line item has been resolved; and
selecting a next authority of the sequence of authorities as the current authority if the non-conforming line item has not been resolved.

6. The method of claim 5, further comprising resolving the non-conforming line item by performing at least one of the following:
determining that the non-conforming line item has been approved by an authority that can approve the non-conforming line item;
determining that the non-conforming line item has been corrected by an authority that can correct the non-conforming line item; and
determining that the non-conforming line item has been rejected.

7. A expense report agent for processing an expense report, comprising:
an interface operable to receive one or more transaction identifiers associated with an expense report, a transaction identifier corresponding to a transaction of one or more transactions, the expense report requesting reimbursement for the one or more transactions; and
a processing engine coupled to the interface and operable to:
automatically request transaction information corresponding to the one or more transaction identifiers from one or more retailer systems;
receive the transaction information from the one or more retailer systems, the transaction information provided in a machine-readable format;
insert the transaction information into the expense report to request the reimbursement for the one or more transactions; and
evaluate the expense report to determine the reimbursement.

8. The expense report agent of claim 7, the processing engine further operable to perform at least one of the following in response to the evaluation:
initiate the reimbursement for the one or more transactions;
deny the reimbursement for the one or more transactions; and
return the expense report to a user system associated with the expense report.

9. The expense report agent of claim 7, the processing engine further operable to evaluate the expense report to determine the reimbursement by:
accessing an expense policy governing the expense report; and
evaluating the expense report in accordance with the expense policy.

10. The expense report agent of claim 7, the processing engine further operable to evaluating the expense report at the expense report agent to determine the reimbursement by:
determining that an expense authorization request is approved; and
evaluating the expense report in accordance with the expense authorization request.

11. The expense report agent of claim 7, the processing engine further operable to evaluate the expense report to determine the reimbursement by:
identifying a non-conforming line item of a plurality of line items of the expense report;
retrieving a chain of command corresponding to the non-conforming line item, the chain of command comprising a sequence of authorities; and
performing the following for at least one authority of the sequence of authorities until the non-conforming line item is resolved;
selecting an authority of the sequence of authorities as a current authority;
sending the expense report to an authority expense report agent corresponding to the current authority;
determining if the non-conforming line item has been resolved; and
selecting a next authority of the sequence of authorities as the current authority if the non-conforming line item has not been resolved.

12. The expense report agent of claim 11, the processing engine further operable to resolve the non-conforming line item by performing at least one of the following:
determining that the non-conforming line item has been approved by an authority that can approve the non-conforming line item;
determining that the non-conforming line item has been corrected by an authority that can correct the non-conforming line item; and
determining that the non-conforming line item has been rejected.

13. Logic for processing an expense report, the logic embodied in a medium and operable to:
receive at an expense report agent one or more transaction identifiers associated with an expense report, a transaction identifier corresponding to a transaction of one or more transactions, the expense report requesting reimbursement for the one or more transactions;
automatically request transaction information corresponding to the one or more transaction identifiers from one or more retailer systems;
receive the transaction information from the one or more retailer systems, the transaction information provided in a machine-readable format;
insert the transaction information into the expense report to request the reimbursement for the one or more transactions; and
evaluate the expense report to determine the reimbursement.

14. The logic of claim 13, further operable to perform at least one of the following in response to the evaluation:
initiate the reimbursement for the one or more transactions;
deny the reimbursement for the one or more transactions; and
return the expense report to a user system associated with the expense report.

15. The logic of claim 13, further operable to evaluate the expense report at the expense report agent to determine the reimbursement by:
accessing an expense policy governing the expense report; and
evaluating the expense report in accordance with the expense policy.

16. The logic of claim 13, further operable to evaluate the expense report to determine the reimbursement by:
determining that an expense authorization request is approved; and
evaluating the expense report in accordance with the expense authorization request.

17. The logic of claim 13, further operable to evaluate the expense report to determine the reimbursement by:
identifying a non-conforming line item of a plurality of line items of the expense report;
retrieving a chain of command corresponding to the non-conforming line item, the chain of command comprising a sequence of authorities; and
performing the following for at least one authority of the sequence of authorities until the non-conforming line item is resolved;
selecting an authority of the sequence of authorities as a current authority;
sending the expense report to an authority expense report agent corresponding to the current authority;
determining if the non-conforming line item has been resolved; and
selecting a next authority of the sequence of authorities as the current authority if the non-conforming line item has not been resolved.

18. The logic of claim 17, further operable to resolve the non-conforming line item by performing at least one of the following:
determining that the non-conforming line item has been approved by an authority that can approve the non-conforming line item;
determining that the non-conforming line item has been corrected by an authority that can correct the non-conforming line item; and
determining that the non-conforming line item has been rejected.

19. A system for processing an expense report, comprising:
means for receiving at an expense report agent one or more transaction identifiers associated with an expense report, a transaction identifier corresponding to a transaction of one or more transactions, the expense report requesting reimbursement for the one or more transactions;
means for automatically requesting transaction information corresponding to the one or more transaction identifiers from one or more retailer systems;
means for receiving the transaction information from the one or more retailer systems, the transaction information provided in a machine-readable format;
means for inserting the transaction information into the expense report to request the reimbursement for the one or more transactions; and
means for evaluating the expense report at the expense report agent to determine the reimbursement.

20. A method for processing an expense report, comprising:
receiving at an expense report agent one or more transaction identifiers associated with an expense report, a transaction identifier corresponding to a transaction of one or more transactions, the expense report requesting reimbursement for the one or more transactions;
automatically requesting transaction information corresponding to the one or more transaction identifiers from one or more retailer systems;
receiving the transaction information from the one or more retailer systems, the transaction information provided in a machine-readable format;
inserting the transaction information into the expense report to request the reimbursement for the one or more transactions;
evaluating the expense report at the expense report agent to determine the reimbursement, the expense report evaluated by:
accessing an expense policy governing the expense report;
evaluating the expense report in accordance with the expense policy;
determining that an expense authorization request is approved; and
evaluating the expense report in accordance with the expense authorization request;
the expense report further evaluated by:
identifying a non-conforming line item of a plurality of line items of the expense report;
retrieving a chain of command corresponding to the non-conforming line item, the chain of command comprising a sequence of authorities; and
performing the following for at least one authority of the sequence of authorities until the non-conforming line item is resolved;
selecting an authority of the sequence of authorities as a current authority;
sending the expense report to an authority expense report agent corresponding to the current authority; and
determining if the non-conforming line item has been resolved, the non-conforming line item resolved by performing at least one of the following:
determining that the non-conforming line item has been approved by an authority that can approve the non-conforming line item;
determining that the non-conforming line item has been corrected by an authority that can correct the non-conforming line item; and
determining that the non-conforming line item has been rejected; and
selecting a next authority of the sequence of authorities as the current authority if the non-conforming line item has not been resolved; and
performing at least one of the following in response to the evaluation:
initiating the reimbursement for the one or more transactions;
denying the reimbursement for the one or more transactions; and
returning the expense report to a user system associated with the expense report.
